(19) United States
(12) Patent Application Publication
(10) Pub. No.: US 2022/0077705 A1
(43) Pub. Date: Mar. 10, 2022

(54) PROTECTION CIRCUIT FOR SECONDARY BATTERY AND SECONDARY BATTERY MODULE

(71) Applicant: SEMICONDUCTOR ENERGY LABORATORY CO., LTD., Atsugi-shi, Kanagawa-ken (JP)

(72) Inventors: Kei TAKAHASHI, Isehara, Kanagawa (JP); Takayuki IKEDA, Atsugi, Kanagawa (JP); Munehiro KOZUMA, Atsugi, Kanagawa (JP); Takanori MATSUZAKI, Atsugi, Kanagawa (JP); Takahiko ISHIZU, Sagamihara, Kanagawa (JP); Takeshi AOKI, Ebina, Kanagawa (JP)

(21) Appl. No.: 17/417,482

(22) PCT Filed: Dec. 18, 2019
(86) PCT No.: PCT/IB2019/060973

§ 371 Date: Jun. 23, 2021

(30) Foreign Application Priority Data
Dec. 28, 2018 (JP) 2018-247508

(51) Int. Cl. H02J 7/00

(52) U.S. Cl. CPC H02J 7/00302; H02J 7/0047; H02J 7/0068; H02J 7/00306

(57) ABSTRACT

A secondary battery deteriorates due to repeated charging and discharging, which leads to a decrease in a battery voltage and a battery capacity. The lifetime of a secondary battery is prolonged by preventing charging at an excessive charging value that would be caused by deterioration of the secondary battery. By performing charge control in consideration of the degree of deterioration of a secondary battery, a longer lifetime of a secondary battery can be achieved. In charging a secondary battery, a charge control circuit controls a current value to a preset value, and a charging current control circuit (specifically a circuit including an error amplifier) included in a protection circuit determines a current value supplied to the secondary battery. That is, the current value supplied to the secondary battery is controlled by both the charge control circuit and the charging current control circuit that is a part of the protection circuit.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a semiconductor device, a display device, a light-emitting device, a power storage device, a lighting device, an electronic device, or a manufacturing method thereof. One embodiment of the present invention relates to a vehicle or an electronic device for vehicles provided in a vehicle. In particular, one embodiment of the present invention relates to a protection circuit for a secondary battery, a charge control method of a secondary battery, an anomaly detection system for a secondary battery, and an electronic device including a secondary battery.

Note that in this specification, a power storage device refers to every element and device having a function of storing power. Examples of the power storage device include a secondary battery such as a lithium-ion secondary battery, a lithium-ion capacitor, an all-solid-state battery, and an electric double layer capacitor.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, tablets, and notebook computers; portable music players; digital cameras; medical equipment; next-generation clean energy vehicles such as hybrid electric vehicles (HEVs), electric vehicles (EVs), and plug-in hybrid electric vehicles (PHEVs); and the like. The lithium-ion secondary batteries are essential as rechargeable energy supply sources for today's information society.

In a portable information terminal, an electric vehicle, or the like, a plurality of secondary batteries connected in series or in parallel and provided with a protection circuit (also referred to as a protection IC) is used as a battery pack (also referred to as an assembled battery). The protection IC is appropriately provided with, for example, a circuit that senses an overcharge voltage (Overcharge), an overdischarge voltage (Over discharge), a charging overcurrent, a discharge overcurrent, or a short.

Note that a battery pack means a container (a metal can or a film exterior body) in which a plurality of secondary batteries and a predetermined circuit are stored for easy handling of secondary batteries. The battery pack has an ECU (Electronic Control Unit) in order to manage the operation state.

The secondary battery used in an electric vehicle or a hybrid electric vehicle deteriorates due to the number of charging, discharge depth, charging current, charging environment (temperature change), or the like. The deterioration also depends on the usage of the user; and charging temperatures, frequency of fast charging, charging amount from regenerative braking, charging timing with a regenerative brake, and the like might be related to the deterioration.

Although a secondary battery gradually deteriorates due to repeated use, charging is performed with the same amount of current as that before the secondary battery deteriorates. Conventionally, in the case where a secondary battery has a small remaining capacity, CC charging is performed first and then switched to CV charging after the voltage reaches a predetermined voltage.

Patent Document 1 discloses a coulomb counter for measuring the capacity of a secondary battery, which includes a transistor using an oxide semiconductor.

### REFERENCE

### Patent Document

[Patent Document 1]

United States Patent Application Publication No. 2014/0184314

### SUMMARY OF THE INVENTION

### Problems to be Solved by the Invention

Secondary batteries incorporated in a portable information terminal and the like are required to satisfy prevention of deterioration, long-term power supply, a reduction in size, inexpensiveness, and the like.

Conventionally, these problems are not solved sufficiently, and a protection IC with a simple circuit configuration is mounted. Many conventional protection ICs sense an overcharge voltage (current), an overdischarge voltage (current), and the like that are uniquely determined, and only control flowing and blocking of a charging current and a discharging current in a battery. In view of this, one object of this specification is to provide a control circuit capable of precise control of a voltage and a current in charging.

In addition, there is a problem in that a secondary battery deteriorates due to repeated charging and discharging, which leads to a decrease in the battery voltage and the battery capacity. One object is to achieve a longer lifetime of a secondary battery by preventing charging at an excessive charging current value that would be caused by deterioration of the secondary battery.

In addition, one object is to achieve a longer lifetime of a secondary battery by performing charge control in consideration of the degree of deterioration of the secondary battery.

In addition, one object is to secure safety by detecting anomaly in a secondary battery, for example, detecting a phenomenon that lowers the safety of the secondary battery early and warning users or changing the charging conditions of the secondary battery.

### Means for Solving the Problems

A protection circuit at least having a function of sensing the degree of deterioration of a secondary battery and a function of adjusting a current flowing to the secondary battery is achieved. Such a protection circuit enables an appropriate control of the current amount in charging, leading to charging under precisely controlled conditions without a significant increase in the circuit scale.

In charging a secondary battery, a charge control circuit controls a current value to a preset value and a charging current control circuit (specifically, a circuit including an error amplifier) included in the protection circuit determines a current value supplied to the secondary battery. That is, the current value supplied to the secondary battery is controlled by both the charge control circuit and the charging current control circuit that is a part of the protection circuit. Note that the error amplifier is an operational amplifier that outputs a voltage obtained by amplifying a voltage difference between two input terminals.

One of the configurations of the invention disclosed in this specification is a protection circuit including a transistor for discharge control and a transistor for charge control that are connected in series and an error amplifier, in which a first input terminal of the error amplifier which receives a reference voltage is electrically connected to a secondary battery and a second input terminal of the error amplifier which receives a feedback signal is electrically connected to a wiring that connects a resistor and the transistor for discharge control.

In addition, a secondary battery module in which a protection circuit is provided for a secondary battery is also one of the present inventions, the secondary battery module has a configuration in which at least the secondary battery, an overcharge detection circuit electrically connected to the secondary battery, an overdischarge detection circuit electrically connected to the secondary battery, a transistor for discharge control electrically connected to the secondary battery, and a transistor for charge control connected in series to the transistor are included; a gate of the transistor for charge control is electrically connected to an output terminal of an error amplifier; the output terminal of the error amplifier is electrically connected to the overcharge detection circuit; a gate of the transistor for discharge control is electrically connected to the overdischarge detection circuit; a resistor is included between the secondary battery and the transistor for discharge control; a first input terminal of the error amplifier which receives a reference voltage is electrically connected to the secondary battery; and a second input terminal of the error amplifier which receives a feedback signal is electrically connected to a wiring that connects the resistor and the transistor for discharge control.

In the above configuration, a charging current value set by the error amplifier is controlled in accordance with a voltage of a DA converter of a main control circuit. The main control circuit constitutes part of the protection circuit and can be formed using a microcomputer. Alternatively, an Noff-CPU (normally-off CPU) can be used for the main control circuit. Note that the normally-off CPU is an integrated circuit including a normally-off transistor that is in a non-conduction state (also referred to as an off state) even when a gate voltage is 0 V. The normally-off transistor can be achieved by using an oxide semiconductor for a semiconductor layer.

In the above configuration, the protection circuit may further include a comparator, a delay sensing logic circuit, an oscillator circuit, a circuit for a battery gauge, or a temperature sensing arithmetic circuit.

Conventionally, only a charge control circuit performs charge control on a secondary battery module in which a protection circuit is provided for a secondary battery. Thus, a user using an apparatus including the secondary battery as a power source might perform charge control that leads to deterioration of the secondary battery.

The charge control circuit performs charging by CCCV charging using two charging methods, specifically a constant current charging and a constant voltage charging; that is, a constant current charging is performed first and then a constant voltage charging is performed after switching at a certain voltage value. In addition, the charge control circuit also has a function of sensing a voltage of a secondary battery, controlling a power transistor (also referred to as a power MOS) so that the voltage does not exceed a certain maximum voltage value, and stopping charging. Conventionally, a power MOS is used as a battery cut-off switch.

In one of the present inventions, the power MOS has a function of determining a current value supplied to a secondary battery with the charging current control circuit (specifically, a circuit including an error amplifier) in addition to the function of the battery cut-off switch.

Note that silicon is mainly used for a power device such as a power MOS, and an n-channel MOSFET or a p-channel MOSFET is formed; alternatively, SiC or GaN can be used as another material. Alternatively, an oxide semiconductor material containing In, Ga, and Zn can also be used.

In addition, in the case of using an oxide semiconductor material for the power MOS, a current value supplied to the secondary battery can be controlled in an analog manner.

A circuit for charge control or a battery control system, which includes a memory circuit including a transistor using an oxide semiconductor, is referred to as BTOS (Battery operating system or Battery oxide semiconductor), in some cases.

Moreover, the charge control circuit can also detect sudden anomaly, specifically a micro short or the like, with a predetermined threshold current value and a sensed current value. The internal resistance decreases when a micro short occurs; hence the amount of current that flows to a healthy secondary battery becomes relatively small and a large amount of current flows to a secondary battery in which anomaly has occurred, which is dangerous. By the charge control circuit, the controlled current value is kept and the current value can be monitored. Anomaly in a secondary battery can be detected early by detecting a micro short or the like.

A micro short refers to a minute short in a secondary battery, and is not a short of a positive electrode and a negative electrode of a secondary battery which makes charging and discharging impossible but a phenomenon in which a small amount of short current flows through a minute short portion for a short period. A micro short is presumably caused in the following manner: a plurality of charging and discharging operations generate deterioration, a metal element such as lithium or cobalt is precipitated in the battery, the growth of the precipitate generates a local current concentration in part of a positive electrode and part of a negative electrode, and the function of a separator partially stops or a by-product is generated.

FIG. 14 shows an example of a charge curve that indicates a micro short in the middle of charging. In FIG. 14, the horizontal axis represents charge capacity Cb of a secondary battery and the vertical axis represents a voltage Vb of the secondary battery. For example, a region surrounded by a dotted circle indicates a micro short.

### Effect of the Invention

By performing charge control that adjusts a charging current while monitoring the degree of deterioration of a secondary battery, the lifetime of a charge control system can be prolonged totally.

Furthermore, detection of a micro short or the like leads to early detection of anomaly in the secondary battery, which enables changing the charging conditions to more safe ones or stopping charging.

### BRIEF DESCRIPTION OF THE DRAWINGS

FIG. 1 is a block diagram showing one embodiment of the present invention.

FIG. 2 is an example of a circuit diagram showing one embodiment of the present invention.

FIG. 3A, FIG. 3B, and FIG. 3C are diagrams showing a charging method of a secondary battery.

FIG. 4A, FIG. 4B, and FIG. 4C are diagrams showing a charging method of a secondary battery.

FIG. 5A is a charge curve of a secondary battery and FIG. 5B is a discharge curve of a secondary battery.

FIG. 6A, FIG. 6B, and FIG. 6C are diagrams illustrating a coin-type secondary battery.

FIG. 7A, FIG. 7B, FIG. 7C, and FIG. 7D are diagrams illustrating cylindrical secondary batteries.

FIG. 8A and FIG. 8B are diagrams illustrating an example of a secondary battery.

FIG. 9A, FIG. 9B, and FIG. 9C are diagrams illustrating an example of a secondary battery.

FIG. 10A, FIG. 10B, and FIG. 10C are diagrams illustrating a laminated secondary battery.

FIG. 11A and FIG. 11B are diagrams illustrating a laminated secondary battery.

FIG. 12A, FIG. 12B, FIG. 12C, FIG. 12D, and FIG. 12E are diagrams illustrating examples of small electronic devices and vehicles each including a secondary battery module of one embodiment of the present invention.

FIG. 13A, FIG. 13B, and FIG. 13C are diagrams illustrating examples of a vehicle and a house each including a secondary battery module of one embodiment of the present invention.

FIG. 14 is a diagram showing a charge curve.

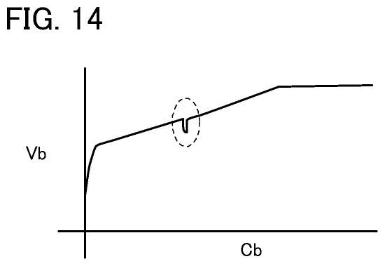

### MODE FOR CARRYING OUT THE INVENTION

Embodiments of the present invention are described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

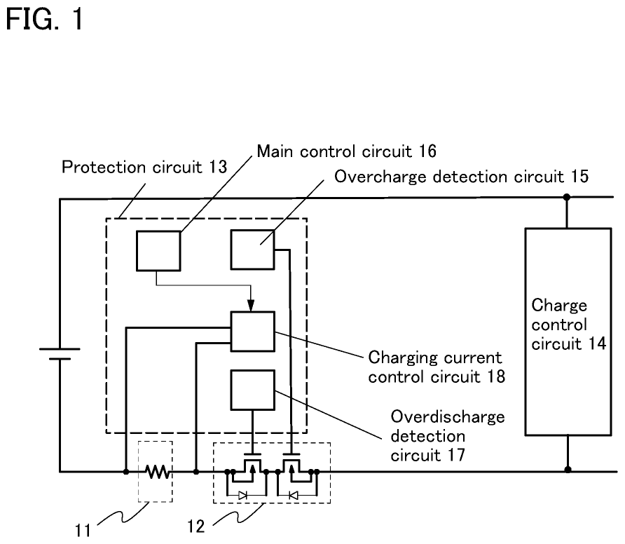

A protection circuit 13 of this embodiment is described with reference to FIG. 1.

This embodiment describes an example in which the protection circuit 13 as one protection IC is electrically connected to a secondary battery. An example is described in which a secondary battery module in which the protection IC is mounted on the secondary battery is incorporated in a portable information terminal or the like as a main power source.

A charge control circuit is connected to the secondary battery, and the charge control circuit has a function of sensing a voltage of the secondary battery, controlling a power MOS 12 so that the voltage does not exceed a certain maximum voltage value, and stopping charging.

The power MOS 12 includes two transistors: a transistor for charge control and a transistor for discharge control that are connected in series. In this embodiment, the power MOS 12 and the protection circuit 13 are separate ICs. An overcharge detection circuit 15 and a gate of the transistor for charge control are electrically connected to each other, and when overcharge is detected, a gate voltage that brings the transistor for charge control into an off state is applied to shut off a current. In addition, an overdischarge detection circuit 17 and a gate of the transistor for discharge control are electrically connected to each other, and when overdischarge is detected, a gate voltage that brings the transistor for discharge control into an off state is applied to shut off a current.

A main control circuit 16 can be regarded as a circuit board on which a microcomputer including a CPU (Central Processing Unit), a memory, an AD converter, a DA converter, and the like are mounted. The main control circuit 16 can estimate the degree of deterioration of the secondary battery in charging. Moreover, in the case of using a normally-off CPU for the main control circuit 16, the usage of power can be minimized by making the main control circuit 16 in an off state except in charging.

The main control circuit 16 can monitor a current, a voltage, temperature, and the like of the secondary battery and estimate the degree of deterioration of the battery using a battery model or the like. For example, the main control circuit 16 estimates the internal state (internal resistance, SOC, or the like) of the battery using a regression model such as a Kalman filter, estimates the degree of deterioration of the battery from the estimated internal resistance value or the like, calculates a charging current value based on the degree of deterioration and the internal state (internal resistance, SOC, temperature, or the like), and then sets the value in a charging current control circuit 18.

A Kalman filter is a kind of infinite impulse response filter. In addition, multiple regression analysis is multivariate analysis and uses a plurality of independent variables in regression analysis. Examples of the multiple regression analysis include a least-squares method. The regression analysis requires a large number of observation values of time series, whereas the Kalman filter has an advantage of being able to obtain an optimal correction coefficient successively as long as there is accumulation of data to some extent. Moreover, the Kalman filter can also be applied to transient time series.

As a method of estimating the internal resistance and the state of charge (SOC) of the secondary battery, a non-linear Kalman filter (specifically an unscented Kalman filter (also referred to as UKF)) can be used. In addition, an extended Kalman filter (also referred to as EKF) can also be used.

The internal resistance and the SOC of the secondary battery can be estimated using a Kalman filter. In the case of estimating the internal resistance and the SOC of the secondary battery, a post-state estimation value is used as an output.

There is no particular limitation on the charging current control circuit 18, and an error amplifier or the like can be used. To the error amplifier, a reference voltage Vref input to a non-inverting terminal and a feedback voltage Vfb input to an inverting terminal are input. Note that a power source voltage Vdd of the error amplifier is generated by a CPU or the like of the main control circuit 16, for example.

The charging current control circuit 18 is connected to a gate of one of the transistors of the power MOS 12, that is, the transistor for a charge control circuit, and thus can adjust the amount of current flowing to the secondary battery by adjusting a gate voltage applied to the gate. Such a control method adjusting the amount of current flowing to the secondary battery using the power MOS 12 is also referred to as an analog control by the power MOS 12.

The configuration shown in FIG. 1 can achieve a secondary battery control system that automatically controls the current amount in charging in accordance with the degree of deterioration of the secondary battery. Note that automatic control here means automatic control without the use of a flash memory or software downloaded or stored in advance in a main memory or the like of a portable information terminal. In the case of control using software that controls the secondary battery, memory capacity or the like for startup of the software needs to be allocated, which limits the functions of the portable information terminal and decreases the processing speed of another operation by a user in charging of the portable information terminal in some cases. In the case of using a flash memory, data of the flash memory are rewritten in accordance with the deterioration of the secondary battery and the written data values are retained, which might increase the power consumption.

Note that the charge control circuit 14 may be mounted on a main substrate or may be independently provided as a separate IC, a microcomputer, or the like. The charge control circuit 14 is designed so that charging is performed under predetermined charging conditions in accordance with the charge and discharge characteristics of the connected secondary battery. The charging conditions are controlled by the system including the protection circuit 13 without adding any change to the charge control circuit 14 even when deterioration occurs in the secondary battery. With the use of the system including the protection circuit 13, the charging current can be controlled in accordance with deterioration of the secondary battery after the deterioration proceeded to some extents.

In addition, the protection circuit 13 can be mounted on the same substrate as the power MOS 12 to form one protection IC. Moreover, a hybrid device in which the power MOS 12 fabricated using an oxide semiconductor for a semiconductor layer is stacked over or combined with a Si LSI may be used as a protection IC.

Furthermore, a resistor 11 can be mounted on the same substrate as the protection circuit 13 to form one protection IC.

### Embodiment 2

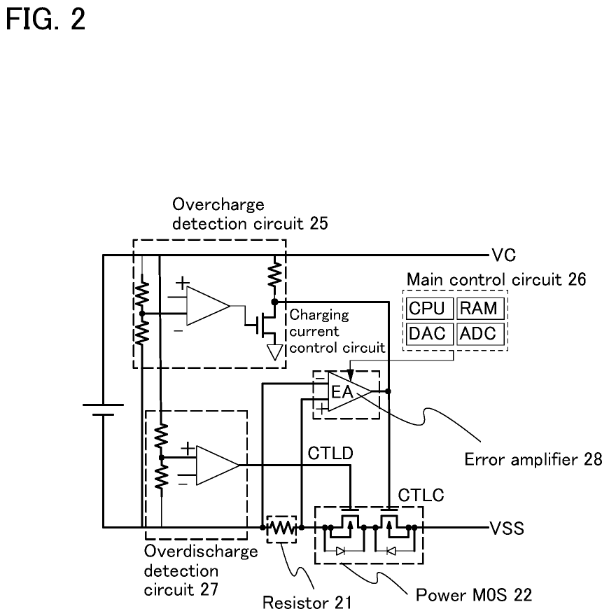

In this embodiment, an example of a protection circuit is shown in FIG. 2.

The protection circuit illustrated in FIG. 2 includes a VC terminal and a VSS terminal.

The VC terminal is electrically connected to one terminal of a secondary battery and connected to an overcharge detection circuit 25 and an overdischarge detection circuit 27.

The overcharge detection circuit 25 has a configuration including at least a hysteresis comparator and a transistor whose gate is electrically connected to an output terminal of the hysteresis comparator.

The overdischarge detection circuit 27 has a configuration including at least a hysteresis comparator. Note that the hysteresis comparator is a circuit having a feature in that two threshold values are used for potential comparison.

A power MOS 22 and a resistor 21 are connected in series to the VSS terminal, and the VSS terminal is electrically connected to the other terminal of the secondary battery.

In this embodiment, an example in which an error amplifier 28 is used as the charging current control circuit is described. To the error amplifier 28, the reference voltage Vref input to a non-inverting terminal and the feedback voltage Vfb input to an inverting terminal are input. Note that the power source voltage Vdd of the error amplifier 28 is generated by a CPU or the like of a main control circuit 26, for example. In addition, an output of the error amplifier 28 is connected to a gate of a transistor for charge control of the power MOS 22.

The main control circuit 26 includes a CPU, a memory (a RAM (Random Access Memory), a ROM, a flash memory, or the like), an AD converter, and a DA converter; the AD converter measures a voltage, a current, and temperature of the battery; and the CPU estimates (calculates) the degree of deterioration of the battery and calculates the charging current value in accordance with the degree of deterioration and the internal state (internal resistance, SOC, temperature, or the like). The main control circuit 26 may be an integrated IC chip including a GPU (Graphics Processing Unit), a PMU (Power Management Unit), or the like) instead of the CPU. Alternatively, the main control circuit 26 may be an FPGA (field-programmable gate array) device.

The main control circuit 26 controls the error amplifier 28 so that the charging current does not exceed a preset current value. Note that the error amplifier 28 is configured to control the charging current in accordance with an output voltage of the DA converter of the main control circuit 26.

With the use of the protection circuit illustrated in FIG. 2, the charging current can be controlled in accordance with deterioration of the secondary battery after the deterioration proceeded to some extents, for example.

In CC charging performed first after the start of charging, when a current that the charge control circuit connected to the terminal VC or the terminal VSS determines to flow to the secondary battery is about to exceed a current value set by the main control circuit 26, the current converges to the set value due to feedback control by the charging current control circuit (the error amplifier 28); accordingly, the voltage increases steeply and the charge control circuit is brought into a CV charging mode. Note that a mode in which CC charging is switched to CV charging before the voltage reaches the switching voltage in charging is referred to as the CV charging mode. Since the protection circuit can change the charging conditions as appropriate in the CV charging mode, intermittent charging is also possible.

CC charging and CV charging will be described below.

### [Charging and Discharging Methods]

The secondary battery can be charged and discharged in the following manner, for example.

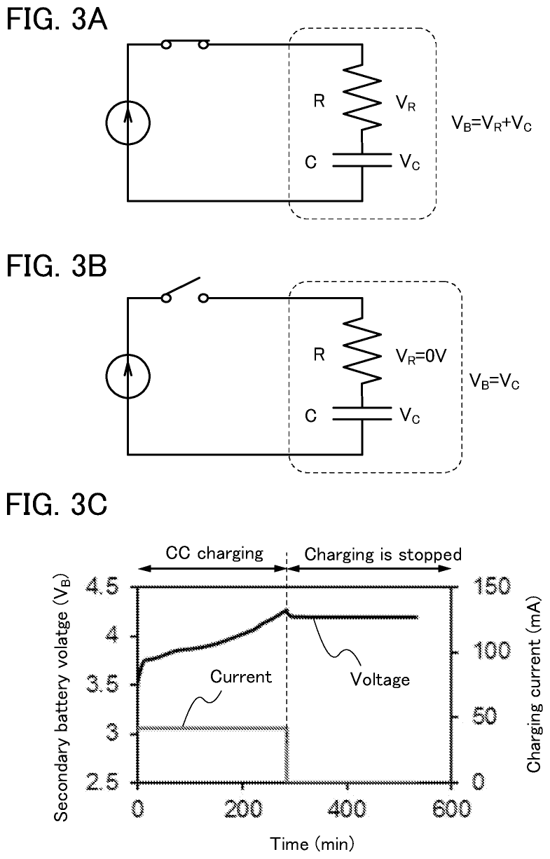

First, CC charging is described as one of the charging methods. CC charging is a charging method in which a constant current is made to flow to a secondary battery in the whole charging period and charging is stopped when the voltage reaches a predetermined voltage. The secondary battery is assumed to be an equivalent circuit with internal resistance R and secondary battery capacitance C as illustrated in FIG. 3A. In this case, a secondary battery voltage V_{B} is the sum of a voltage V_{R} applied to the internal resistance R and a voltage V_{C} applied to the secondary battery capacitance C.

While the CC charging is performed, a switch is on as illustrated in FIG. 3A, so that a constant current I flows to the secondary battery. During the period, the current I is constant; thus, in accordance with the Ohm's law (V_{R}=R×I), the voltage V_{R} applied to the internal resistance R is also constant. In contrast, the voltage V_{C} applied to the secondary battery capacitance C increases over time. Accordingly, the secondary battery voltage V_{B} increases over time.

When the secondary battery voltage V_{B} reaches a predetermined voltage, e.g., 4.3 V, the charging is stopped. When the CC charging is stopped, the switch is turned off as illustrated in FIG. 3B, and the current I becomes 0. Thus, the voltage V_{R} applied to the internal resistance R becomes 0 V. Consequently, the secondary battery voltage Vs decreases.

FIG. 3C shows an example of the secondary battery voltage V_{B} and charging current during a period in which the CC charging is performed and after the CC charging is stopped. The state is shown in which the secondary battery voltage Vs, which increases while the CC charging is performed, slightly decreases after the CC charging is stopped.

Next, CCCV charging, which is a charging method different from the above-described method, is described. CCCV charging is a charging method in which CC charging is performed until the voltage reaches a predetermined voltage and then CV charging is performed until the amount of current flow becomes small, specifically, a termination current value.

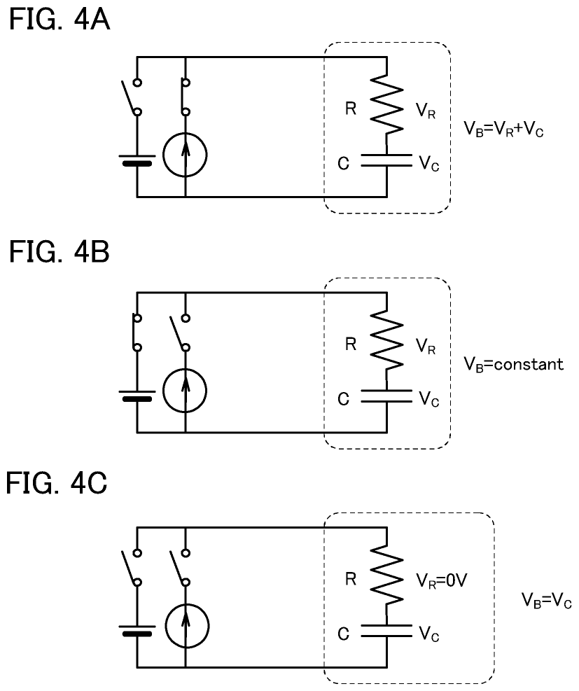

While the CC charging is performed, a switch of a constant current power source is on and a switch of a constant voltage power source is off as illustrated in FIG. 4A, so that the constant current I flows to the secondary battery. During the period, the current I is constant; thus, in accordance with the Ohm's law (V_{R}=R×I), the voltage V_{R} applied to the internal resistance R is also constant. In contrast, the voltage V_{C} applied to the secondary battery capacitance C increases over time. Accordingly, the secondary battery voltage V_{B} increases over time.

When the secondary battery voltage Vs reaches a predetermined voltage, e.g., 4.3 V, the CC charging is switched to the CV charging. While the CV charging is performed, the switch of the constant voltage power source is on and the switch of the constant current power source is off as illustrated in FIG. 4B; thus, the secondary battery voltage V_{B} is constant. In contrast, the voltage V_{C} applied to the secondary battery capacitance C increases over time. Since V_{B}=V_{R}+V_{C} is satisfied, the voltage V_{R} applied to the internal resistance R decreases over time. As the voltage V_{R} applied to the internal resistance R decreases, the current I flowing to the secondary battery also decreases in accordance with the Ohm's law (V_{R}=R×I).

When the current I flowing to the secondary battery becomes a predetermined current, e.g., a current corresponding to approximately 0.01 C, charging is stopped. When the CCCV charging is stopped, all the switches are turned off as illustrated in FIG. 4C, so that the current I becomes 0. Thus, the voltage V_{R} applied to the internal resistance R becomes 0 V. However, the voltage V_{R} applied to the internal resistance R becomes sufficiently small by the CV charging; thus, even when a voltage drop no longer occurs in the internal resistance R, the secondary battery voltage Vs hardly decreases.

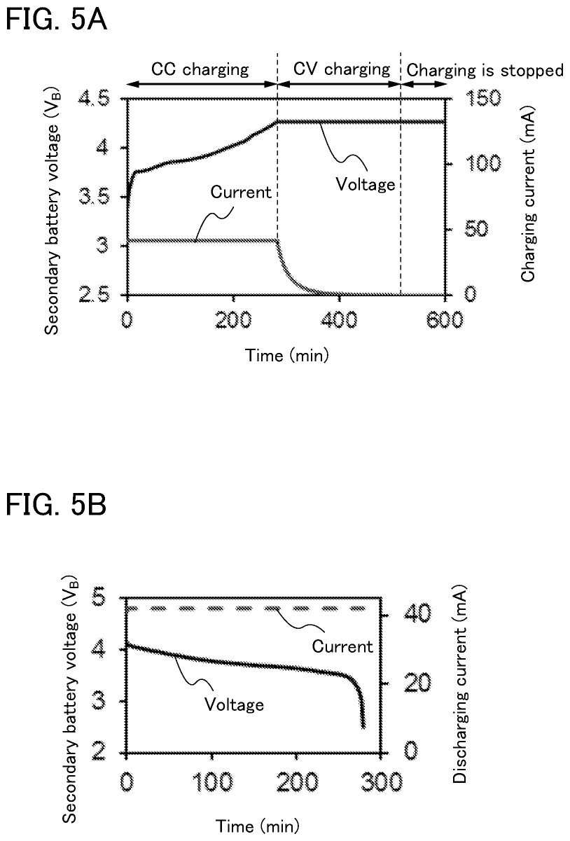

FIG. 5A shows an example of the secondary battery voltage V_{B} and charging current while the CCCV charging is performed and after the CCCV charging is stopped. The state is shown in which the secondary battery voltage V_{B} hardly decreases even after the CCCV charging is stopped.

Next, CC discharging, which is one of discharging methods, is described. CC discharging is a discharging method in which a constant current is made to flow from the secondary battery in the whole discharging period, and discharging is stopped when the secondary battery voltage Vs reaches a predetermined voltage, e.g., 2.5 V.

FIG. 5B shows an example of the secondary battery voltage V_{B} and discharging current while the CC discharging is performed. The state is shown in which the secondary battery voltage V_{B} decreases as discharging proceeds.

Next, a discharging rate and a charging rate are described. The discharging rate refers to the relative ratio of discharging current to battery capacity and is expressed in a unit C. A current corresponding to 1 C in a battery with a rated capacity X (Ah) is X (A). The case where discharging is performed at a current of 2X (A) is rephrased as to perform discharging at 2 C, and the case where discharging is performed at a current of X/5 (A) is rephrased as to perform discharging at 0.2 C. The same applies to the charging rate; the case where charging is performed at a current of 2X (A) is rephrased as to perform charging at 2 C, and the case where charging is performed at a current of X/5 (A) is rephrased as to perform charging at 0.2 C.

This embodiment can be freely combined with Embodiment 1.

### Embodiment 3

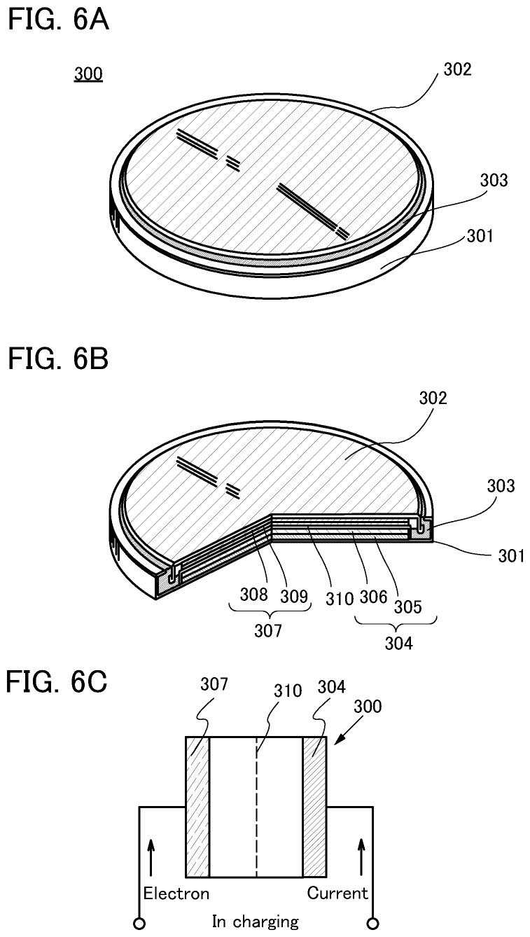

An example of a coin-type secondary battery is described. FIG. 6A is an external view of a coin-type (single-layer flat type) secondary battery, and FIG. 6B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that an active material layer may be formed over only one surface of each of the positive electrode 304 and the negative electrode 307 used for the coin-type secondary battery 300.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and a separator 310 are immersed in the electrolyte solution; as illustrated in FIG. 6B, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

Here, a current flow in charging a secondary battery is described with reference to FIG. 6C. When a secondary battery using lithium is regarded as a closed circuit, lithium ions transfer and a current flows in the same direction. Note that in the secondary battery using lithium, an anode and a cathode interchange in charging and discharging, and an oxidation reaction and a reduction reaction interchange; thus, an electrode with a high reaction potential is called a positive electrode and an electrode with a low reaction potential is called a negative electrode. For this reason, in this specification, the positive electrode is referred to as a “positive electrode” or a “+ electrode (plus electrode)” and the negative electrode is referred to as a “negative electrode” or a “− electrode (minus electrode)” in all the cases where charging is performed, discharging is performed, a reverse pulse current is supplied, and a charging current is supplied. The use of terms an “anode” and a “cathode” related to oxidation reaction and reduction reaction might cause confusion because the anode and the cathode interchange in charging and discharging. Thus, the terms “anode” and “cathode” are not used in this specification. If the term the “anode” or the “cathode” is used, it should be clearly mentioned that the anode or the cathode is which of the one in charging or in discharging and corresponds to which of the positive electrode (plus electrode) or the negative electrode (minus electrode).

Two terminals in FIG. 6C are connected to a charger, and the secondary battery 300 is charged. As the charging of the secondary battery 300 proceeds, a potential difference between electrodes increases.

### [Cylindrical Secondary Battery]

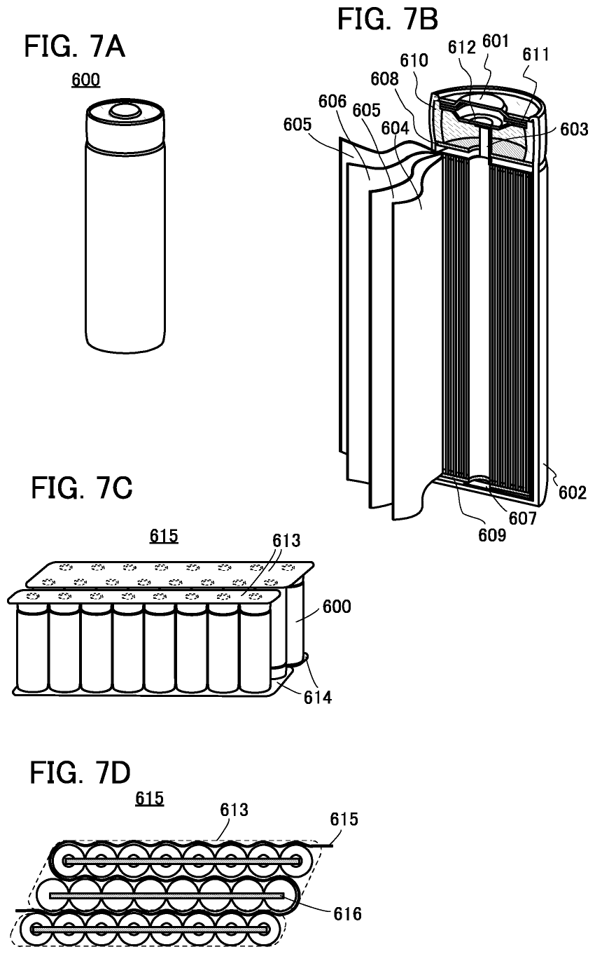

Next, an example of a cylindrical secondary battery is described with reference to FIG. 7. A cylindrical secondary battery 600 includes, as illustrated in FIG. 7A, a positive electrode cap (battery lid) 601 on the top surface and a battery can (outer can) 602 on the side and bottom surfaces. The positive electrode cap and the battery can (outer can) 602 are insulated from each other by a gasket (insulating packing) 610.

FIG. 7B is a diagram schematically illustrating a cross-section of the cylindrical secondary battery. Inside the battery can 602 having a hollow cylindrical shape, a battery element in which a belt-like positive electrode 604 and a belt-like negative electrode 606 are wound with a separator 605 therebetween is provided. Although not illustrates, the battery element is wound centering around a center pin. One end of the battery can 602 is closed and the other end thereof is open. For the battery can 602, a metal having a corrosion-resistant property to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is sandwiched between a pair of insulating plates 608 and 609 that face each other. Furthermore, a nonaqueous electrolyte (not illustrated) is injected inside the battery can 602 provided with the battery element. As the nonaqueous electrolyte, a nonaqueous electrolyte similar to that for a coin-type secondary battery can be used.

Since a positive electrode and a negative electrode that are used for a cylindrical storage battery are wound, active materials are preferably formed on both surfaces of a current collector. A positive electrode terminal (positive electrode current collector lead) 603 is connected to the positive electrode 604, and a negative electrode terminal (negative electrode current collector lead) 607 is connected to the negative electrode 606. For both the positive electrode terminal 603 and the negative electrode terminal 607, a metal material such as aluminum can be used. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC (Positive Temperature Coefficient) element 611. The safety valve mechanism 612 cuts off electrical connection between the positive electrode cap 601 and the positive electrode 604 when the internal pressure of the battery increases exceeding a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramics or the like can be used for the PTC element.

As illustrated in FIG. 7C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 7D is a top view of the module 615. The conductive plate 613 is shown by a dotted line for clarity of the drawing. As illustrated in FIG. 7D, the module 615 may include a wiring 616 electrically connecting the plurality of secondary batteries 600 with each other. It is possible to provide the conductive plate over the wiring 616 to overlap with each other. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature. A heating medium included in the temperature control device 617 preferably has an insulating property and incombustibility.

### [Structure Examples of Secondary Battery]

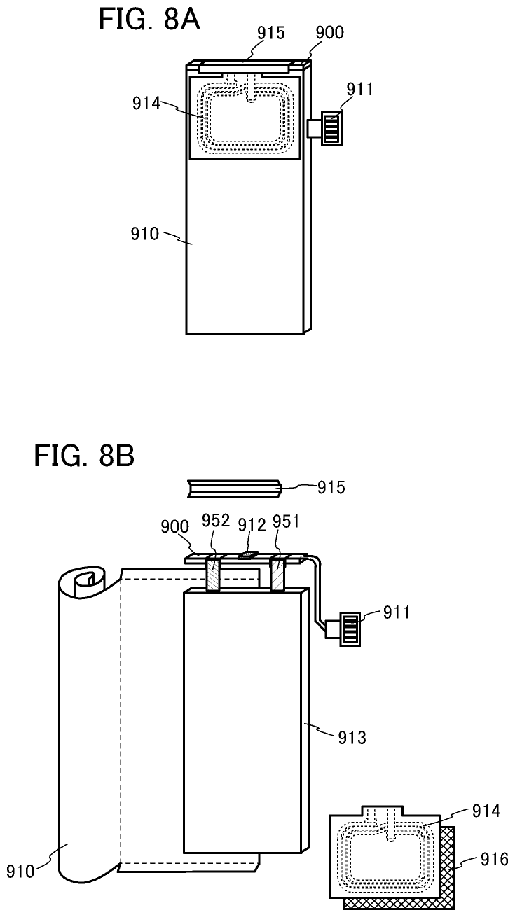

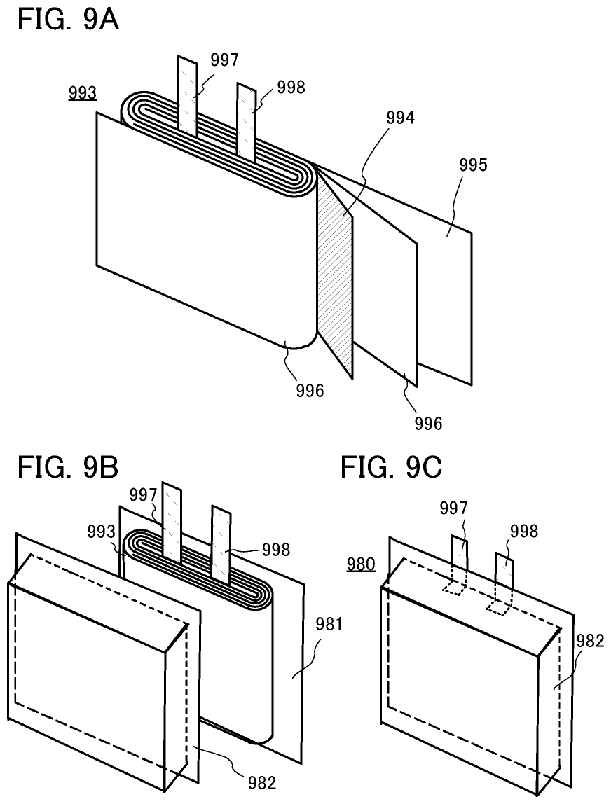

Other structural examples of secondary batteries will be described with reference to FIG. 8 and FIG. 9.

FIG. 8A and FIG. 8B are diagrams illustrating external appearances of a secondary battery. The secondary battery includes a circuit board 900 and a secondary battery 913. A label 910 is attached to the secondary battery 913. Moreover, as illustrated in FIG. 8B, the secondary battery includes a terminal 951, a terminal 952, an antenna 914, and an antenna 915.

The circuit board 900 includes terminals 911 and a circuit 912. The terminals 911 are connected to the terminal 951, the terminal 952, the antenna 914, the antenna 915, and the circuit 912. Note that a plurality of terminals 911 may be provided to serve separately as a control signal input terminal, a power supply terminal, a temperature sensing terminal (also referred to as a T terminal), and the like.

The circuit 912 is a protection circuit including an overcharge detection circuit, an overdischarge detection circuit, a power MOS, or the like. For the circuit board 900 on which the protection circuit is mounted, a diode, a resistor, a thermistor (e.g., a temperature sensor), or the like may be provided. The circuit 912 is designed to sense a resistance value of the thermistor which changes depending on temperature and to stop charging when the resistance value exceeds a threshold value (charging temperature range).

The circuit 912 may be provided on the rear surface of the circuit board 900. Note that the shapes of the antenna 914 and the antenna 915 are not limited to coil shapes, and may be linear shapes or plate shapes, for example. An antenna such as a planar antenna, an aperture antenna, a traveling-wave antenna, an EH antenna, a magnetic-field antenna, or a dielectric antenna may be used. Alternatively, the antenna 914 or the antenna 915 may be a flat-plate conductor. This flat-plate conductor can serve as one of conductors for electric field coupling. That is, the antenna 914 or the antenna 915 can serve as one of the two conductors included in a capacitor. Thus, electric power can be transmitted and received not only by an electromagnetic field or a magnetic field but also by an electric field.

The line width of the antenna 914 is preferably larger than the line width of the antenna 915. This makes it possible to increase the amount of power received by the antenna 914.

The secondary battery includes a layer 916 between the secondary battery 913 and each of the antenna 914 and the antenna 915. The layer 916 has a function of preventing the influence of the secondary battery 913 on an electromagnetic field, for example. As the layer 916, for example, a magnetic body can be used.

Note that the structure of the secondary battery is not limited to that in FIG. 8.

Another structure example of the secondary battery 913 is described with reference to FIG. 9.

A laminated secondary battery 980 is described with reference to FIG. 9. The laminated secondary battery 980 includes a wound body 993 illustrated in FIG. 9A. The wound body 993 includes a negative electrode 994, a positive electrode 995, and separators 996. The wound body 993 is obtained by winding a sheet of a stack in which the negative electrode 994 and the positive electrode 995 overlap each other with the separator 996 sandwiched therebetween.

As illustrated in FIG. 9B, the wound body 993 is packed in a space formed by bonding a film 981 and a film 982 having a depressed portion that serve as exterior bodies by thermocompression bonding or the like, whereby the secondary battery 980 illustrated in FIG. 9C can be formed. The wound body 993 includes a lead electrode 997 and a lead electrode 998, and is immersed in an electrolyte solution inside a space surrounded by the film 981 and the film 982 having a depressed portion.

For the film 981 and the film 982 having a depressed portion, a metal material such as aluminum or a resin material can be used, for example. With the use of a resin material for the film 981 and the film 982 having a depressed portion, the film 981 and the film 982 having a depressed portion can be changed in their forms when external force is applied; thus, a flexible storage battery can be formed.

Although FIG. 9B and FIG. 9C illustrate an example of using two films for sealing, a space may be formed by bending one film and the wound body 993 may be packed in the space.

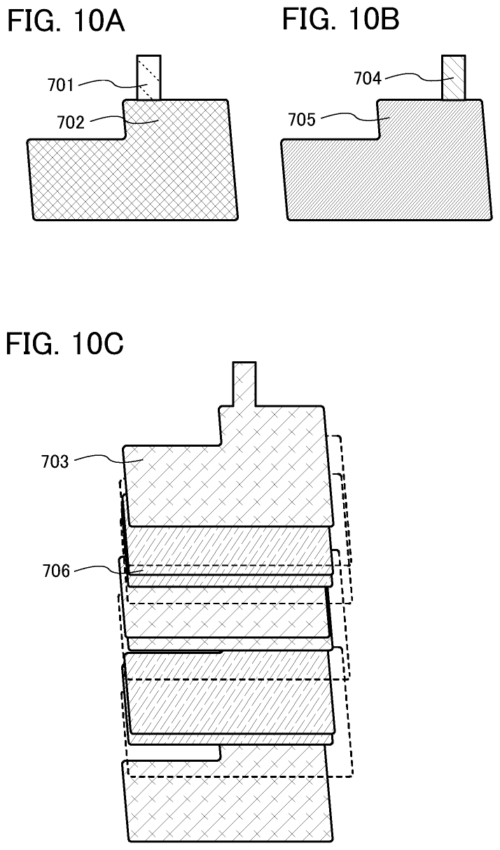

In addition, FIG. 9 illustrates an example in which the secondary battery 980 includes a wound body in a space formed by films serving as exterior bodies; however, as illustrated in FIG. 10, for example, a secondary battery may include a plurality of positive electrodes, separators, and negative electrodes in a space formed by films serving as exterior bodies.

FIG. 10A illustrates a positive electrode including a positive electrode current collector 701 and a positive electrode active material layer 702 that have an L-shape. The positive electrode includes a region where the positive electrode current collector 701 is partly exposed (hereinafter, such a region is referred to as a tab region). In addition, FIG. 10B illustrates a negative electrode including a negative electrode current collector 704 and a negative electrode active material layer 705 that have an L-shape. The negative electrode includes a region where the negative electrode current collector 704 is partly exposed, that is, a tab region.

FIG. 10C shows a perspective view in which four layers of positive electrodes 703 and four layers of negative electrodes 706 are stacked. Note that in FIG. 10C, separators provided between the positive electrodes 703 and the negative electrodes 706 are shown by dotted lines for simplicity.

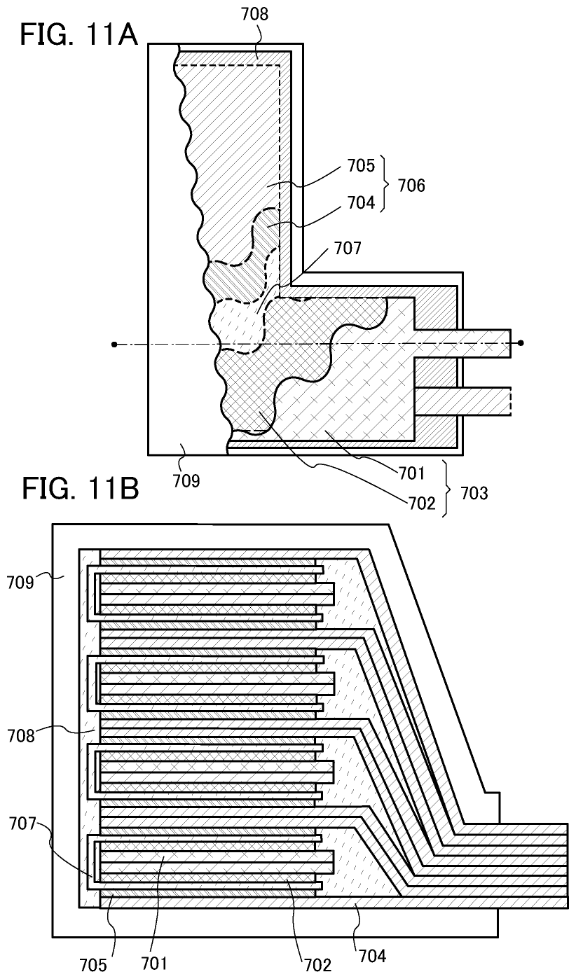

A laminated secondary battery illustrated in FIG. 11A includes a positive electrode 703 including an L-shaped positive electrode current collector 701 and a positive electrode active material layer 702, a negative electrode 706 including an L-shaped negative electrode current collector 704 and a negative electrode active material layer 705, a separator 707, an electrolyte solution 708, and an exterior body 709. The separator 707 is provided between the positive electrode 703 and the negative electrode 706 in the exterior body 709. The exterior body 709 is filled with the electrolyte solution 708.

In the laminated secondary battery illustrated in FIG. 11A, the positive electrode current collector 701 and the negative electrode current collector 704 also serve as terminals for electrical contact with the outside. For this reason, the positive electrode current collector 701 and the negative electrode current collector 704 may be arranged so that parts of the positive electrode current collector 701 and the negative electrode current collector 704 are exposed to the outside of the exterior body 709. Alternatively, a lead electrode and the positive electrode current collector 701 or the negative electrode current collector 704 may be bonded to each other by ultrasonic welding, and instead of the positive electrode current collector 701 and the negative electrode current collector 704, the lead electrode may be exposed to the outside of the exterior body 709.

As the exterior body 709 of the laminated secondary battery, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

FIG. 11B shows an example of a cross-sectional structure of the laminated secondary battery. Although not illustrated in FIG. 11A for simplicity, actually a plurality of electrode layers are included.

In FIG. 11B, the number of electrode layers is 16, for example. FIG. 11B shows a structure including 8 layers of the negative electrode current collectors 704 and 8 layers of the positive electrode current collectors 701, i.e., 16 layers in total. Note that FIG. 11B illustrates a cross section of a lead portion of the positive electrode, which is cut along the chain line in FIG. 11A, and the 8 negative electrode current collectors 704 are bonded to each other by ultrasonic welding. It is needless to say that the number of electrode layers is not limited to 16, and may be more than 16 or less than 16. In the case of a large number of electrode layers, the secondary battery can have higher capacity. In addition, in the case where the number of electrode layers is small, the secondary battery can be thinner.

### Embodiment 4

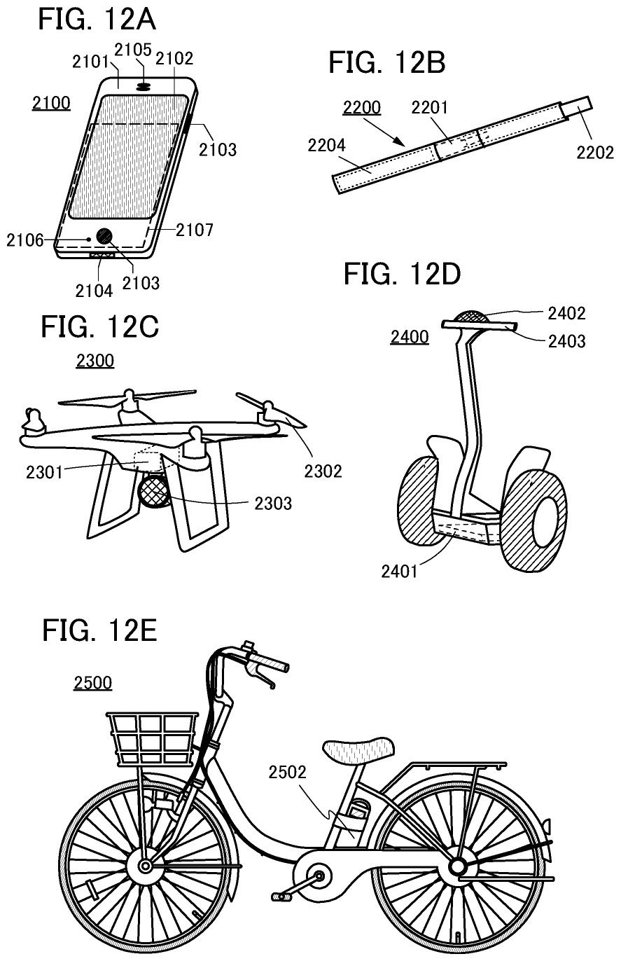

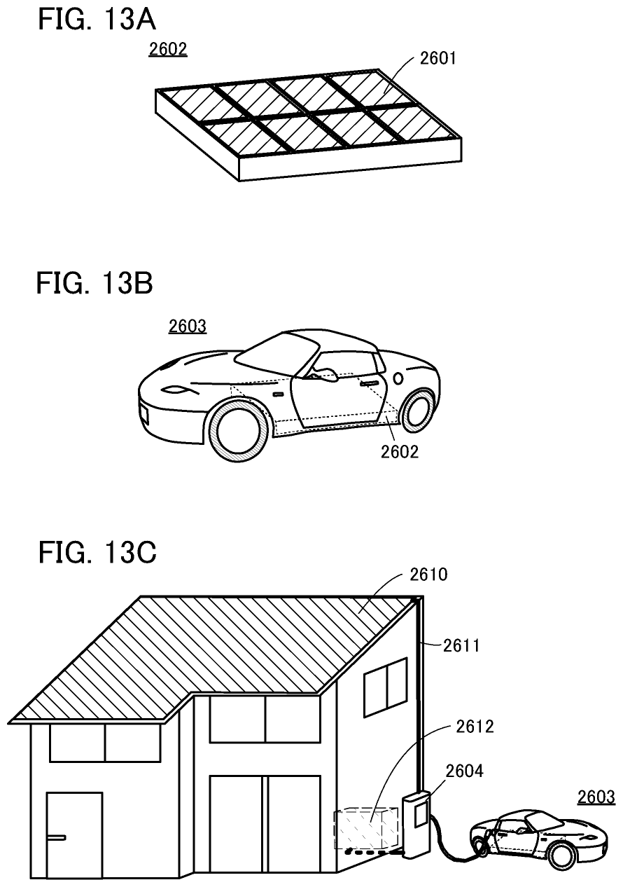

In this embodiment, examples of electronic devices each including the secondary battery module described in the above embodiments will be described with reference to FIG. 12 and FIG. 13. Note that the secondary battery module includes at least a secondary battery and a protection circuit.

First, examples of small electronic devices each including the secondary battery module of one embodiment of the present invention will be described with reference to FIG. 12A to FIG. 12C.

FIG. 12A illustrates an example of a mobile phone. A mobile phone 2100 includes a housing 2101 in which a display portion 2102 is incorporated, an operation button 2103, an external connection port 2104, a speaker 2105, a microphone 2106, and the like. Note that the mobile phone 2100 includes a secondary battery module 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, mutual communication with a headset capable of wireless communication enables hands-free calling.

Moreover, the mobile phone 2100 includes the external connection port 2104, and data can be directly transmitted to and received from another information terminal via a connector.

In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, an acceleration sensor, or the like is preferably mounted.

FIG. 12B is a perspective view of a device called a cigarette smoking device (electronic cigarette). In FIG. 12B, an electronic cigarette 2200 includes a heating element 2201 and a secondary battery module 2204 that supplies electric power to the heating element 2201. A stick 2202 is inserted into this, and the stick 2202 is heated by the heating element 2201. To increase safety, a protection circuit for preventing overcharge and overdischarge of the secondary battery module 2204 may be electrically connected to the secondary battery module 2204. The secondary battery module 2204 illustrated in FIG. 12B includes an external terminal for connection to a charger. The secondary battery module 2204 is a tip portion when the electronic cigarette 2200 is held; thus, it is desirable that the secondary battery module 2204 have a short total length and be lightweight. Since the secondary battery module of one embodiment of the present invention has a high level of safety, the small and lightweight electronic cigarette 2200 that can be used safely for a long time over a long period can be provided.

FIG. 12C illustrates an unmanned aircraft 2300 including a plurality of rotors 2302. The unmanned aircraft 2300 includes a secondary battery module 2301 of one embodiment of the present invention, a camera 2303, and an antenna (not illustrated). The unmanned aircraft 2300 can be remotely controlled through the antenna. The secondary battery module of one embodiment of the present invention has a high level of safety, and thus can be used safely for a long time over a long period and is suitable as the secondary battery module incorporated in the unmanned aircraft 2300.

Next, examples of vehicles each including the secondary battery module of one embodiment of the present invention will be described with reference to FIG. 12D, FIG. 12E, and FIG. 13.

FIG. 12D illustrates an electric two-wheeled vehicle 2400 using the secondary battery module of one embodiment of the present invention. The electric two-wheeled vehicle 2400 includes a secondary battery module 2401 of one embodiment of the present invention, a display portion 2402, and a handle 2403. The secondary battery module 2401 can supply electricity to a motor serving as a power source. The display portion 2402 can display the remaining battery level of the secondary battery module 2401, the velocity and horizontal state of the electric two-wheeled vehicle 2400, and the like.

FIG. 12E is an example of an electric bicycle using the secondary battery module of one embodiment of the present invention. An electric bicycle 2500 includes a battery pack 2502. The battery pack 2502 includes the secondary battery module of one embodiment of the present invention.

The battery pack 2502 can supply electricity to a motor that assists a rider. Furthermore, the battery pack 2502 can be taken off from the electric bicycle 2500 and carried. The battery pack 2502 and the electric bicycle 2500 may each include a display portion for displaying the remaining battery level and the like.

Furthermore, as illustrated in FIG. 13A, a secondary battery module 2602 including a plurality of secondary batteries 2601 of one embodiment of the present invention may be mounted on a hybrid electric vehicle (HEV), an electric vehicle (EV), a plug-in hybrid electric vehicle (PHEV), or another electronic device.

FIG. 13B illustrates an example of a vehicle including the secondary battery module 2602. A vehicle 2603 is an electric vehicle that runs using an electric motor as a power source. Alternatively, the vehicle 2603 is a hybrid electric vehicle that can run using a power source appropriately selected from an electric motor and an engine. The vehicle 2603 using the electric motor includes a plurality of ECUs (Electronic Control Units) and performs engine control by the ECUs. The ECU includes a microcomputer. The ECU is connected to a CAN (Controller Area Network) provided in the electric vehicle. The CAN is a type of a serial communication standard used as an in-vehicle LAN. The use of one embodiment of the present invention can achieve a vehicle with a high level of safety and a high mileage.

The secondary battery not only drives the electric motor (not illustrated) but also can supply electric power to a light-emitting device such as a headlight or a room light. Furthermore, the secondary battery can supply electric power to a display device and a semiconductor device included in the vehicle 2603, such as a speedometer, a tachometer, and a navigation system.

In the vehicle 2603, the secondary batteries included in the secondary battery module 2602 can be charged by being supplied with electric power from external charging equipment by a plug-in system, a contactless power feeding system, or the like.

FIG. 13C illustrates a state in which the vehicle 2603 is supplied with electric power from ground-based charging equipment 2604 through a cable. In charging, a given method such as CHAdeMO (registered trademark) or Combined Charging System may be employed as a charging method, the standard of a connector, or the like as appropriate. For example, with a plug-in technique, the secondary battery module 2602 incorporated in the vehicle 2603 can be charged by being supplied with electric power from the outside. The charging can be performed by converting AC electric power into DC electric power through a converter, such as an AC-DC converter. The charging equipment 2604 may be provided for a house as illustrated in FIG. 13C, or may be a charging station provided in a commercial facility.

Although not illustrated, the vehicle may include a power receiving device so that it can be charged by being supplied with electric power from an above-ground power transmitting device in a contactless manner. In the case of the contactless power feeding system, by incorporating a power transmitting device in a road or an exterior wall, charging can be performed not only when the vehicle is stopped but also when driven. In addition, this contactless power feeding system may be utilized to transmit and receive power between vehicles. Furthermore, a solar cell may be provided in the exterior of the vehicle to charge the secondary battery while the vehicle is stopped or driven. To supply electric power in such a contactless manner, an electromagnetic induction method or a magnetic resonance method can be used.

The house illustrated in FIG. 13C includes a power storage system 2612 including the secondary battery module of one embodiment of the present invention and a solar panel 2610. The power storage system 2612 is electrically connected to the solar panel 2610 through a wiring 2611 or the like. The power storage system 2612 may be electrically connected to the ground-based charging equipment 2604. The power storage system 2612 can be charged with electric power generated by the solar panel 2610. The secondary battery module 2602 included in the vehicle 2603 can be charged with the electric power stored in the power storage system 2612 through the charging equipment 2604.

The electric power stored in the power storage system 2612 can also be supplied to other electronic devices in the house. Thus, with the use of the power storage system 2612 of one embodiment of the present invention as an uninterruptible power supply, electronic devices can be used even when electric power cannot be supplied from a commercial power supply due to power failure or the like.

This embodiment can be implemented in appropriate combination with any of the other embodiments.

### REFERENCE NUMERALS

11: resistance, 12: power MOS, 13: protection circuit, 14: charge control circuit, 15: overcharge detection circuit, 16: main control circuit, 17: overdischarge detection circuit, 18: charging current control circuit, 21: resistance, 22: power MOS, 25: overcharge detection circuit, 26: main control circuit, 27: overdischarge detection circuit, 28: error amplifier, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 612: safety valve mechanism, 613: conductive plate, 614: conductive plate, 615: module, 616: wiring, 617: temperature control device, 701: positive electrode current collector, 702: positive electrode active material layer, 703: positive electrode, 704: negative electrode current collector, 705: negative electrode active material layer, 706: negative electrode, 707: separator, 708: electrolyte solution, 709: exterior body, 900: circuit board, 910: label, 911: terminal, 912: circuit, 913: secondary battery, 914: antenna, 915: antenna, 916: layer, 951: terminal, 952: terminal, 980: secondary battery, 981: film, 982: film, 993: wound body, 994: negative electrode, 995: positive electrode, 996: separator, 997: lead electrode, 998: lead electrode, 2100: mobile phone, 2101: housing, 2102: display portion, 2103: operation button, 2104: external connection port, 2105: a speaker, 2106: microphone, 2107: secondary battery module, 2200: electric cigarette, 2201: heating element, 2202: stick, 2204: secondary battery module, 2300: unmanned airplane, 2301: secondary battery module, 2302: rotor, 2303: camera, 2400: electric bicycle, 2401: secondary battery module, 2402: display portion, 2403: handle, 2500: electric bicycle, 2502: battery pack, 2601: secondary battery, 2602: secondary battery module, 2603: vehicle, 2604: charging equipment, 2610: solar panel, 2611: wiring, 2612: power storage system

1. A secondary battery module comprising:
a secondary battery;
an overcharge detection circuit electrically connected to the secondary battery;
an overdischarge detection circuit electrically connected to the secondary battery;
a first transistor for discharge control electrically connected to the secondary battery; and
a second transistor for charge control electrically connected in series to the first transistor,
wherein a gate of the second transistor is connected to an output terminal of an error amplifier,
wherein the output terminal of the error amplifier is electrically connected to the overcharge detection circuit,
wherein a gate of the first transistor is electrically connected to the overdischarge detection circuit,
wherein a resistor is included between the secondary battery and the first transistor,
wherein a first input terminal of the error amplifier receiving a reference voltage is electrically connected to the secondary battery, and
wherein a second input terminal of the error amplifier receiving a feedback signal is electrically connected to a wiring connecting the resistor and the first transistor.

2. The secondary battery module according to claim 1, wherein a charging current value set in the error amplifier is controlled in accordance with an output voltage of a DA converter of a main control circuit.

3. A protection circuit for a secondary battery, comprising:
a first transistor for discharge control;
a second transistor for charge control connected in series to the first transistor; and
an error amplifier,
wherein a first input terminal of the error amplifier receiving a reference voltage is electrically connected to a secondary battery, and
wherein a second input terminal of the error amplifier receiving a reference signal is electrically connected to a wiring connecting a resistor and the first transistor.

4. The protection circuit for a secondary battery, according to claim 3, further comprising an overdischarge detection circuit,
wherein the overdischarge detection circuit is electrically connected to a gate of the first transistor.

5. The protection circuit for a secondary battery, according to claim 3, further comprising an overcharge detection circuit,
wherein the overcharge detection circuit is electrically connected to a gate of the second transistor.

6. The protection circuit for a secondary battery, according to claim 3, wherein a semiconductor layer of the first transistor and a semiconductor layer of the second transistor each comprise silicon.

7. The protection circuit for a secondary battery, according to claim 3, wherein a semiconductor layer of the first transistor and a semiconductor layer of the second transistor each comprise an oxide semiconductor.

8. The secondary battery module according to claim 1, wherein a semiconductor layer of the first transistor and a semiconductor layer of the second transistor each comprise silicon.

9. The secondary battery module according to claim 1, wherein a semiconductor layer of the first transistor and a semiconductor layer of the second transistor each comprise an oxide semiconductor.
